(19) United States
(12) Patent Application Publication
(10) Pub. No.: US 2024/0382914 A1
(43) Pub. Date: Nov. 21, 2024

(54) STIRRING DEVICE

(71) Applicant: CONTEMPORARY AMPEREX TECHNOLOGY CO., LIMITED, Ningde (CN)

(72) Inventors: Ganyu XU, Ningde (CN); Haohao YAN, Ningde (CN); Jiancheng CAI, Ningde (CN); Haohua YU, Ningde (CN); Guangsheng CHEN, Ningde (CN)

(21) Appl. No.: 18/500,738

(22) Filed: Nov. 2, 2023

Related U.S. Application Data
(63) Continuation of application No. PCT/CN2023/099988, filed on Jun. 13, 2023.

(30) Foreign Application Priority Data
May 17, 2023 (CN) 202321194890.5

(51) Int. Cl. B01F 27/85; B01F 27/1122; B01F 27/113; B01F 27/191; B01F 27/902; B01F 27/91; B01F 35/53; B01F 35/92

(52) U.S. Cl. CPC B01F 27/85; B01F 27/1122; B01F 27/113; B01F 27/191; B01F 27/9021; B01F 27/91; B01F 35/5312; B01F 35/92

(57) ABSTRACT

A stirring device includes a tank, a first stirring mechanism, a second stirring mechanism, and a flow blocking mechanism located in the tank and arranged on a side wall of the tank. A first stirring shaft of the first stirring mechanism is located in a middle part of the tank, and one end of the first stirring shaft is provided with a radial-flow stirring paddle located in the tank. A second stirring shaft of the second stirring mechanism is located on one side of the first stirring shaft. The second stirring shaft and the first stirring shaft are arranged in a radial direction of the tank. One end of the second stirring shaft is provided with an axial-flow stirring paddle located in the tank. The flow blocking mechanism is configured to block movement of materials in the tank.

### CROSS-REFERENCE TO RELATED APPLICATION

This application is a continuation of International Application No. PCT/CN2023/099988, filed on Jun. 13, 2023, which claims priority to Chinese Application No. 202321194890.5, filed on May 17, 2023, the entire contents of both of which are incorporated herein by reference.

### TECHNICAL FIELD

The present application relates to the field of mixing apparatus technologies, and in particular, to a stirring device.

### BACKGROUND ART

A stirring device is a simple and commonly used mixing device. The stirring device is usually composed of a tank and a stirrer that penetrates into the tank. The stirrer stirs materials in the tank to disperse the materials and achieve material mixing.

In the related technology, after materials are put into the tank, the materials move synchronously with the stirrer. Due to differences in particle sizes of the materials, for the same material in the radial direction of the tank, the larger the particle size of particles is, the greater the centrifugal force is, and the farther the particles are away from a central axis of the stirrer; therefore, the particle size of the materials closer to the central axis of the stirrer is smaller, and the particle size of the materials farther away from the central axis of the stirrer is larger, resulting in radial stratification of the materials and a poor mixing effect.

### SUMMARY

In view of the above problems, the present application provides a stirring device to alleviate the problem of radial stratification of materials, thereby improving material dispersion and stirring effects.

In order to solve the above technical problems, the present application proposes a stirring device. The stirring device includes: a tank; a first stirring mechanism, a first stirring shaft thereof being located in a middle part of the tank, and one end of the first stirring shaft being provided with a radial-flow stirring paddle located in the tank; and a second stirring mechanism, a second stirring shaft thereof being located on one side of the first stirring shaft, the second stirring shaft and the first stirring shaft being arranged in a radial direction of the tank, and one end of the second stirring shaft being provided with an axial-flow stirring paddle located in the tank; and the stirring device further includes: a flow blocking mechanism, located in the tank and arranged on a side wall of the tank, and configured to block the movement of materials in the tank.

The radial-flow stirring paddle on the first stirring shaft in the middle part of the tank may be used for driving the materials in the tank to move in the radial direction of the tank, and the axial-flow stirring paddle on the second stirring shaft located on the side of the first stirring shaft may be used for driving the materials in the tank to move in an axial direction of the tank, so that the materials in the tank move horizontally and vertically. Because the second stirring shaft of the second stirring mechanism is located on one side of the first stirring shaft of the first stirring mechanism, the materials moving vertically by the second stirring mechanism are capable of being squeezed to the other side of the first stirring shaft, so as to form a circulation that flows horizontally and vertically, so that the materials in the tank may be evenly dispersed, thereby alleviating the problem of radial stratification of the materials, and then improving the material dispersion and stirring effects.

The flow blocking mechanism is arranged in the tank, so that the circulation that flows horizontally and vertically in the tank hits the flow blocking mechanism, and the materials after hitting a flow blocking plate are scattered irregularly, which increases the hedging movement between the materials, and then makes the materials in various positions in the tank get uniform dispersion; therefore, it is capable of further alleviating the problem of radial stratification of the materials, and further improving the material dispersion and stirring effects.

In some embodiments, the flow blocking mechanism includes: the flow blocking plate arranged on the side wall in the axial direction of the tank.

The flow blocking plate is arranged on the side wall of the tank in the axial direction of the tank, so that the flow blocking plate is capable of blocking and dispersing the materials at different depths in the tank, thereby improving the material dispersion and stirring effects.

In some embodiments, the flow blocking plate is arranged to be perpendicular to the side wall.

After the materials in the tank move to the side wall of the tank, they will flow in a circumferential direction of the side wall of the tank to form a horizontal circulation. Therefore, arranging the flow blocking plate to be perpendicular to the side wall of the tank is capable of increasing a blocking area of the flow blocking plate on the materials, thereby being capable of improving the material dispersion effect.

In some embodiments, the flow blocking plate is fixedly connected to the side wall.

The fixed connection between the flow blocking plate and the side wall of the tank is capable of improving the stability between the flow blocking plate and the tank, thereby improving the quality of the stirring device, and is also capable of simplifying a mounting structure of the flow blocking plate, thereby simplifying the structure of the stirring device.

In some embodiments, the flow blocking mechanism includes a plurality of flow blocking plates, and the plurality of flow blocking plates are arranged symmetrically with respect to the first stirring shaft.

The first stirring shaft drives the materials in the tank to move in the radial direction of the tank and forms the horizontal circulation, and therefore, arranging the plurality of flow blocking plates on the side wall of the tank in the axial direction of the tank and symmetrically with respect to the first stirring shaft is capable of improving the dispersion and stirring effects of the materials at various positions in the tank.

In some embodiments, the axial-flow stirring paddle includes: a propeller connected to one end of the second stirring shaft located in the tank, wherein an axial direction of the propeller is arranged parallel to an axial direction of the second stirring shaft, and the propeller is configured to drive the materials in the tank to move in the axial direction.

The propeller is arranged coaxially with the second stirring shaft, and the propeller is driven by the second stirring shaft to rotate. When the propeller rotates, it is capable of generating an upward or downward propulsion force on the materials, so that the materials in the tank move vertically.

In some embodiments, the second stirring mechanism includes a plurality of propellers, and the plurality of propellers are arranged on the second stirring shaft at intervals in the axial direction of the second stirring shaft.

The plurality of propellers are all arranged coaxially with the second stirring shaft, which is capable of improving the propulsion force of the second stirring mechanism on the materials in the axial direction; and the plurality of propellers are arranged at intervals, which is capable of reducing resistances of the propellers to the materials.

In some embodiments, the radial-flow stirring paddle includes: an anchor-type stirring paddle, which is connected to one end of the first stirring shaft located in the tank, and an axial direction of the anchor-type stirring paddle is arranged parallel to an axial direction of the first stirring shaft. The anchor-type stirring paddle is configured to drive the materials in the tank to move in the radial direction of the tank.

The anchor-type stirring paddle is driven by the first stirring shaft to rotate, and when the anchor-type stirring paddle rotates, it is capable of generating a propulsion force in the radial direction to the materials, so that the materials in the tank move in the radial direction. The anchor-type stirring paddle has advantages of a wide viscosity range and low energy consumption. Therefore, it is capable of improving an application range of the stirring device and saving power consumption.

In some embodiments, the first stirring mechanism further includes: a supporting member arranged on a bottom wall of the tank and configured to support one end of the first stirring shaft connected to the anchor-type stirring paddle.

The supporting member is fixedly arranged on the bottom wall of the tank, and the first stirring shaft is connected to the anchor-type stirring paddle and extends to the supporting member, and is rotatably connected to the supporting member, so that the supporting member is capable of limiting the first stirring shaft and is capable of causing the first stirring shaft to rotate smoothly with respect to the tank.

In some embodiments, the anchor-type stirring paddle is arranged close to the bottom wall of the tank, and is located between the propeller and the bottom wall in the axial direction of the tank.

The anchor-type stirring paddle is arranged close to the bottom wall of the tank, so that the anchor-type stirring paddle is capable of driving the materials to move in the radial direction of the tank to the side wall of the tank and then move upward along the side wall, so that the rising materials are driven by the propeller to move upward continuously. Because the anchor-type stirring paddle is arranged away from the top of the tank, the centrifugal force of the materials on an upper part of the tank is small, and the materials are capable of being pushed to the other side of the first stirring shaft, that is, the side where the propeller is not arranged, and the materials are not affected by the propeller on this side, or in other words, is hardly affected, and the materials will move downward on the other side, thereby forming a circulation that moves vertically and horizontally.

In some embodiments, the stirring device further includes: a jacket arranged outside the tank and configured to accommodate a temperature regulator.

The jacket outside the tank is capable of adjusting the temperature of the materials in the tank through the injected temperature regulator such as a cooling liquid or a heating liquid, so that the materials may always maintain at a suitable temperature, thereby improving the material mixing effect.

Different from the related art, the stirring device of the present application includes the tank, the first stirring mechanism, and the second stirring mechanism. The radial-flow stirring paddle on the first stirring shaft in the middle part of the tank may be used for driving the materials in the tank to move in the radial direction of the tank, and the axial-flow stirring paddle on the second stirring shaft located on the side of the first stirring shaft may be used for driving the materials in the tank to move in the axial direction of the tank, so that the materials in the tank move horizontally and vertically. Because the second stirring shaft of the second stirring mechanism is located on one side of the first stirring shaft of the first stirring mechanism, the materials moving vertically by the second stirring mechanism are capable of being squeezed to the other side of the first stirring shaft, so as to form a circulation that flows horizontally and vertically, so that the materials in the tank may be evenly dispersed, thereby alleviating the problem of radial stratification of the materials, and then improving the material dispersion and stirring effects.

### DESCRIPTION OF DRAWINGS

In order to explain technical solutions of embodiments of the present application more clearly, a brief introduction of drawings to be used for describing the embodiments will be made below. Apparently, the drawings described below are merely some embodiments of the present application, and other drawings can be obtained according to these drawings by those of ordinary skill in the art without creative efforts.

FIG. 1 is a schematic structural diagram of a first embodiment of a stirring device according to the present application;

FIG. 2 is a schematic structural diagram of a second embodiment of a stirring device according to the present application;

FIG. 3 is a schematic structural diagram of another embodiment of a flow blocking plate according to the present application;

FIG. 4 is a schematic structural diagram of a third embodiment of a stirring device according to the present application;

FIG. 5 is a schematic structural diagram of a fourth embodiment of a stirring device according to the present application;

FIG. 6 is a schematic structural diagram of a fifth embodiment of a stirring device according to the present application; and

FIG. 7 is a schematic structural diagram of a sixth embodiment of a stirring device according to the present application.

Reference numerals: tank 11, first stirring mechanism 12, second stirring mechanism 13, upper head 14, supporting leg 15, side wall 111, bottom wall 112, first stirring shaft 121, anchor-type stirring paddle 122, first driving member 123, supporting member 124, second stirring shaft 131, propeller 132, second driving member 133, flow blocking plate 21, first flow blocking portion 311, second flow blocking portion 312, jacket 61.

### DETAILED DESCRIPTION

Embodiments of the technical solutions of the present application will be described in detail below with reference to the drawings. The following embodiments are only used to more clearly illustrate the technical solution of the present application, and therefore are only used as examples and cannot be used to limit the protection scope of the present application.

Unless otherwise defined, all technical and scientific terms used herein have the same meaning as commonly understood by those skilled in the art belonging to the technical field of the present application; the terms used herein are intended only for the purpose of describing specific embodiments and are not intended to limit the present application; the terms “including” and “having” and any variations thereof in the specification and the claims of the present application and in the description of the drawings above are intended to cover non-exclusive inclusion.

In the description of the embodiments of the present application, the technical terms “first,” “second,” and the like are used only to distinguish between different objects, and cannot be construed as indicating or implying a relative importance or implicitly specifying the quantity, particular order, or primary and secondary relation of the technical features indicated. In the description of the embodiments of the present application, “a plurality of” means two or more, unless otherwise explicitly and specifically defined.

Reference herein to “an embodiment” means that a particular feature, structure, or characteristic described in connection with the embodiment may be included in at least one embodiment of the present application. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

In the description of the embodiments of the present application, the term “a plurality of” refers to two or more (including two), and similarly, “a plurality of groups” refers to two or more (including two) groups, and “a plurality of sheets” refers to two or more (including two) sheets.

In the description of the embodiments of the present application, the orientation or position relationship indicated by the technical terms “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” “axial,” “radial,” “circumferential,” and the like are based on the orientation or position relationship shown in the drawings and are intended to facilitate the description of the embodiments of the present application and simplify the description only, rather than indicating or implying that the apparatus or element referred to must have a particular orientation or be constructed and operated in a particular orientation, and therefore are not to be interpreted as limitations on the embodiments of the present application.

In the description of the embodiments of the present application, unless otherwise expressly specified and limited, the technical terms “mount,” “join,” “connect,” “fix,” and the like should be understood in a broad sense, such as, a fixed connection, a detachable connection, or an integral connection; a mechanical connection, or an electrical connection; a direct connection, an indirect connection through an intermediate medium, an internal connection of two elements, or interaction between two elements. For those of ordinary skill in the art, the specific meanings of the above terms in the embodiments of the present application may be understood according to specific situations.

A mixture with good uniformity is crucial to the quality of a product made from it. For embodiment, in a preparation process of batteries, a pulping process is first used, in which powdery positive and negative are active materials are mixed separately with special solvents and binders, and evenly stirred to make positive and negative electrode materials in the form of slurry. A qualified finished battery is obtained by successively adopting processes such as film coating, assembling, and chemical formation. Apparently, pulping is the first and most important step in preparing batteries, and the subsequent process steps of battery preparation can be carried out only after qualified slurry is obtained.

During pulping, it is needed to mix different materials in a special solvent, so the slurry needs to be stirred. Therefore, the function of a stirring device determines a mixing effect of the slurry. The stirring device needs to be high in efficiency, high in automation, capable of reducing labor intensity, good in stirring effect, and so on.

After the slurry is put into a tank, the slurry moves synchronously with the stirring device. Due to differences in particle sizes of the slurry, for the same slurry in the radial direction of the tank, the larger the particle size of particles is, the greater the centrifugal force is, and the farther the particles are away from a central axis of the stirring device; therefore, the particle size of particles of the slurry closer to the central axis of the stirrer is smaller, and the particle size of the particles farther away from the central axis of the stirring device is larger, resulting in radial stratification of the slurry and a poor mixing effect.

In order to solve the above problems, the present application proposes a stirring device that is capable of forming a circulation that flows vertically and horizontally in the tank, so that materials in the tank may be evenly dispersed, so that the problem of radial stratification of the materials is capable of being alleviated, thereby improving the material dispersion and stirring effects.

The stirring device disclosed in the embodiments of the present application may be used for pulping for batteries to improve the performance of the batteries. The battery is used in an electrical apparatus using the battery as a power supply or various energy storage systems using the battery as an energy storage element. The electrical apparatus may be, but is not limited to, a mobile phone, a tablet, a laptop, an electric toy, an electric tool, a battery vehicle, an electric vehicle, a ship, a spacecraft, and the like. The electric toy may include fixed or mobile electric toys, such as game consoles, electric car toys, electric ship toys, electric airplane toys, and the like. The spacecraft may include airplanes, rockets, space shuttles, spaceships, and the like.

The stirring device disclosed in the embodiments of the present application may also be used for mixing, dispersing, and stirring other materials.

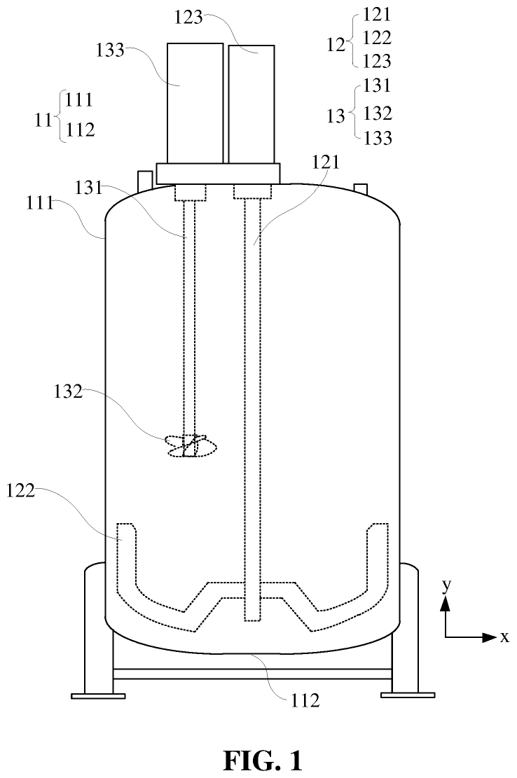

The present application first proposes a stirring device, as shown in FIG. 1, and FIG. 1 is a schematic structural diagram of a first embodiment of the stirring device according to the present application. The stirring device of the present embodiment includes a tank 11, a first stirring mechanism 12, and a second stirring mechanism 13. A first stirring shaft 121 of the first stirring mechanism 12 is located in the middle part of the tank 11, and one end of the first stirring shaft 121 is provided with a radial-flow stirring paddle located in the tank 11. A second stirring shaft 131 of the second stirring mechanism 13 is arranged in the tank 11 and is located on one side of the first stirring shaft 121 of the first stirring mechanism 12, and one end of the second stirring shaft 131 is provided with an axial-flow stirring paddle located in the tank 11.

The second stirring shaft 131 is located on one side of the first stirring mechanism 12, and the second stirring shaft 131 and the first stirring shaft 121 are arranged in a radial direction of the tank 11.

The first stirring mechanism 12 is configured to drive the materials in the tank 11 to move in the radial direction x of the tank 11. The second stirring shaft 131 of the second stirring mechanism 13 is arranged in the tank 11 and located on the side of the first stirring shaft 121 of the first stirring mechanism 12, and is configured to drive the materials to move in an axial direction y of the tank 11.

The radial-flow stirring paddle refers to a stirrer that drives the materials to move in the radial direction x of the tank 11; the axial-flow stirring paddle refers to a stirrer that drives the materials to move in the axial direction y of the tank 11. The tank 11 refers to a container for filling the materials, which includes an accommodating chamber for filling the materials and having an opening, as well as a side wall 111 and a bottom wall 112 forming the accommodating chamber. The middle part of the tank 11 refers to a position of a central axis of the accommodating chamber or a position near the central axis. The radial direction x of the tank 11 refers to a direction perpendicular to the central axis. The axial direction y of the tank 11 refers to a direction parallel to the central axis, that is, a depth direction of the tank 11. The stirring mechanism refers to a component or an assembly that drives the materials to move, and its stirring shaft refers to a shaft body that drives the stirring paddle in the stirring mechanism to move. The second stirring shaft 131 of the second stirring mechanism 13 being located at the side of the first stirring shaft 121 of the first stirring mechanism 12 means that the second stirring shaft 131 is located between the position of the central axis of the tank 11 or the position near the central axis and a side wall of the accommodating chamber.

The shape of the tank 11 in the embodiment of the present application is not limited to a barrel shape, a spherical shape, and the like.

The first stirring mechanism 12 of the present embodiment is used as a central stirring mechanism of the stirring device, and is configured to drive the materials in the tank 11 to move in the radial direction of the tank 11, that is, to move horizontally. The second stirring mechanism 13 is used as an auxiliary stirring mechanism of the stirring device, and is configured to drive the materials in the tank 11 to move in the axial direction of the tank 11, that is, to move vertically.

The present embodiment may utilize the radial-flow stirring paddle on the first stirring shaft 121 in the middle part of the tank 11 to drive the materials in the tank 11 to move in the radial direction of the tank 11, and may use the axial-flow stirring paddle on the second stirring shaft 131 located on the side of the first stirring shaft 121 to drive the materials in the tank 11 to move in the axial direction of the tank 11, so that the materials in the tank move horizontally and vertically. Because the second stirring shaft 131 of the second stirring mechanism 13 is located on one side of the first stirring shaft 121 of the first stirring mechanism 12, the materials moving vertically by the second stirring mechanism 13 are capable of being squeezed to the other side of the first stirring shaft 121, so as to form a circulation that flows horizontally and vertically, so that the materials in the tank may be evenly dispersed, thereby alleviating the problem of radial stratification of the materials, and then improving the material dispersion and stirring effects.

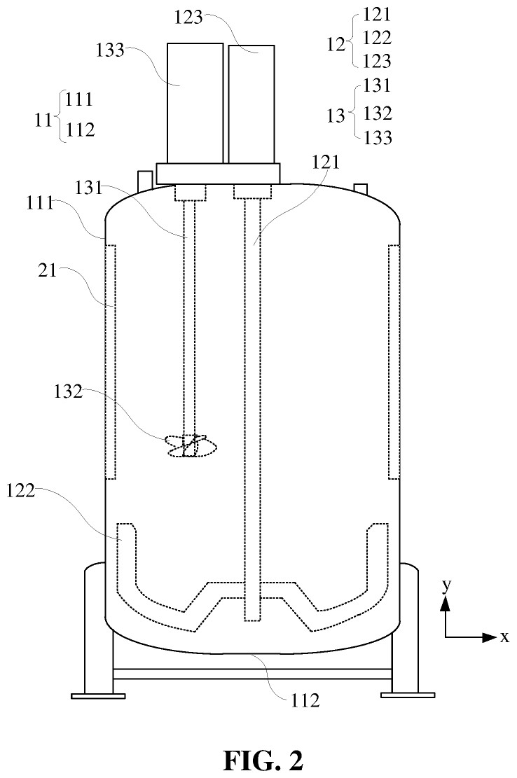

In some embodiments, as shown in FIG. 2, FIG. 2 is a schematic structural diagram of a second embodiment of a stirring device according to the present application. The stirring device of the present embodiment further includes: a flow blocking mechanism (refer to a flow blocking plate 21 in FIG. 2) located in the tank 11 and arranged on the side wall of the tank 11, and the flow blocking mechanism is configured to block the movement of the materials in the tank.

The side wall 111 of the tank 11 refers to the side wall of its accommodating chamber; and the flow blocking mechanism refers to a component or an assembly that blocks the movement of the materials.

The present embodiment further arranges the flow blocking mechanism in the tank 11, so that the circulation that flows horizontally and vertically in the tank 11 hits the flow blocking mechanism, and the materials after hitting the flow blocking plate 21 is scattered irregularly, which increases the hedging movement between the materials, and then makes the materials in various positions in the tank 11 get uniform dispersion; therefore, it is capable of further alleviating the problem of radial stratification of the materials, and further improving the material dispersion and stirring effects.

In some embodiments, the flow blocking mechanism includes: the flow blocking plate 21, and the flow blocking plate 21 is arranged on the side wall 111 of the tank 11 in the axial direction of the tank 11.

Arrangement of the flow blocking plate 21 in the axial direction of the tank 11 refers to that the flow blocking plate 21 is arranged and extended in the axial direction of the tank 11, that is, a length direction of the flow blocking plate 21 is arranged parallel to the axial direction of the tank 11.

The flow blocking plate 21 is arranged on the side wall 111 of the tank 11 in the axial direction of the tank 11, so that the flow blocking plate 21 is capable of blocking and dispersing the materials at different depths in the tank 11, thereby improving the material dispersion and stirring effects.

In some embodiments, the flow blocking plate 21 is arranged to be perpendicular to the side wall 111 of the tank 11.

The arrangement of the flow blocking plate 21 to be perpendicular to the inner wall of the tank 11 refers to that a width direction of the flow blocking plate 21 is perpendicular to the inner wall of the tank.

After the materials in the tank 11 move to the side wall 111 of the tank 11, they will flow in a circumferential direction of the side wall 111 of the tank 11 to form a horizontal circulation. Therefore, arranging the flow blocking plate 21 to be perpendicular to the side wall 111 of the tank 11 is capable of increasing a blocking area of the flow blocking plate 21 on the materials, thereby being capable of improving the material dispersion effect.

In some embodiments, the flow blocking plate 21 is fixedly connected to the side wall 111 of the tank 11.

The fixed connection between components refers to a non-detachable connection between the components after a product leaves the factory.

The fixed connection between the flow blocking plate 21 and the side wall 111 of the tank 11 in the present embodiment may not be limited to welding connection, integral molding, and the like.

The present embodiment fixedly connect the flow blocking plate 21 and the side wall 111 of the tank 11, which is capable of improving the stability between the flow blocking plate 21 and the tank 11, thereby improving the quality of the stirring device, and is also capable of simplifying a mounting structure of the flow blocking plate 21, thereby simplifying the structure of the stirring device.

In some embodiments, the flow blocking mechanism in the present embodiment includes a plurality of flow blocking plates 21, and the plurality of flow blocking plates 21 are arranged symmetrically with respect to the first stirring shaft 121.

The plurality of flow blocking plates 21 arranged symmetrically with respect to the first stirring shaft 121 refers to that they are arranged in an axisymmetric manner by taking the first stirring shaft 121 as a central axis.

The first stirring shaft 121, serving as a central stirring shaft of the stirring device, drives the materials in the tank 11 to move in the radial direction of the tank 11 and forms the horizontal circulation, and therefore, arranging the plurality of flow blocking plates 21 on the side wall 111 of the tank 11 in the axial direction of the tank 11 and symmetrical with respect to the first stirring shaft 121 is capable of improving the dispersion and stirring effects of the materials at various positions in the tank 11.

In some embodiments, the flow blocking plate 21 may further be provided with a through hole.

Through the arrangement of the through hole, the materials may be prevented from being accumulated between the flow blocking plate 21 and the tank 11, and the blocked materials are capable of flowing out from the through hole.

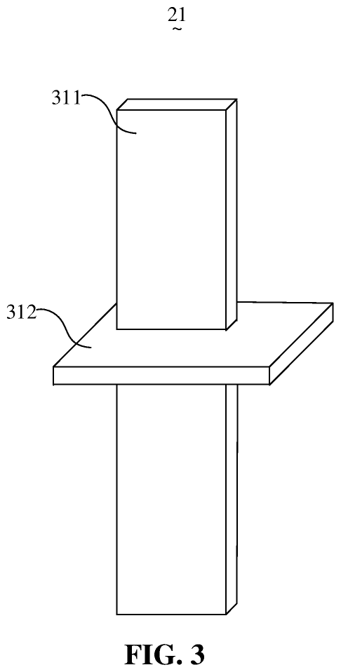

In some embodiments, as shown in FIG. 3, FIG. 3 is a schematic structural diagram of another embodiment of a flow blocking plate according to the present application. The flow blocking plate 21 of the present embodiment includes a first flow blocking portion 311 and a second flow blocking portion 312, wherein the first flow blocking portion 311 is arranged on the side wall 111 of the tank 11 in the axial direction of the tank 11, and its specific structure and working principle may be obtained with reference to the flow blocking plate 21 in the above embodiment. The second flow blocking portion 312 is perpendicular to the first flow blocking portion 311 and the axial direction of the tank 11 respectively, that is, a length direction of the second flow blocking portion 312 is perpendicular to the axial direction of the tank 11, and its width direction is parallel to the radial direction of the tank 11.

In the present embodiment, the materials are blocked by the first flow blocking portion 311 and the second flow blocking portion 312 having flow blocking effects in different directions, which is capable of improving the dispersing and stirring effects of the materials at various positions in the tank 11.

In some embodiments, as shown in FIG. 1 and FIG. 2, the axial-flow stirring paddle includes: a propeller 132 connected to one end of the second stirring shaft 131 located in the tank 11, wherein an axial direction of the propeller 132 is arranged parallel to an axial direction of the second stirring shaft 131, and the propeller 132 is configured to drive the materials in the tank 11 to move in the axial direction of the tank 11.

The propeller 132 is arranged coaxially with the second stirring shaft 131, and the propeller 132 is driven by the second stirring shaft 131 to rotate. When the propeller 132 rotates, it is capable of generating an upward or downward propulsion force on the materials, so that the materials in the tank 11 move vertically.

Optionally, the second stirring mechanism 13 further includes a second driving member 133 arranged outside the tank 11, and the second driving member 133 is connected to the other end of the second stirring shaft 131 to drive the second stirring shaft 131 to rotate, thereby driving the propeller 132 to rotate.

A driving member refers to a component or an assembly capable of generating a driving force. The second driving member 133 is capable of realizing automatic stirring of the second stirring mechanism 13.

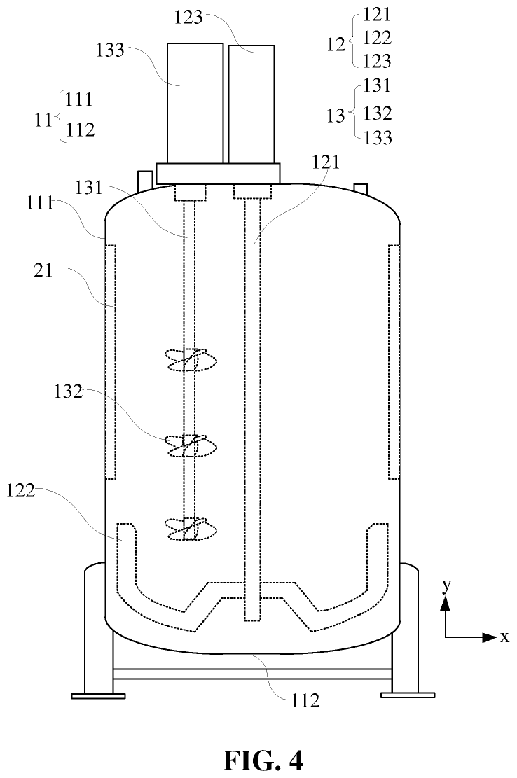

In some embodiments, as shown in FIG. 4, FIG. 4 is a schematic structural diagram of a third embodiment of a stirring device according to the present application, the second stirring mechanism 13 of the present embodiment includes a plurality of propellers 132, and the plurality of propellers 132 are arranged on the second stirring shaft 131 at intervals in the axial direction of the second stirring shaft 131.

The plurality of propellers 132 in the present embodiment are all arranged coaxially with the second stirring shaft 131, which is capable of improving the propulsion force of the second stirring mechanism 13 on the materials in the axial direction; and the plurality of propellers 132 are arranged at intervals, which is capable of reducing resistances of the propellers 132 to the materials.

In some embodiments, as shown in FIG. 1, FIG. 2, and FIG. 4, the radial-flow stirring paddle includes: an anchor-type stirring paddle 122, which is connected to one end of the first stirring shaft 121 located in the tank 11, and an axial direction of the anchor-type stirring paddle 122 is arranged parallel to an axial direction of the first stirring shaft 121. The anchor-type stirring paddle 122 is configured to drive the materials in the tank 11 to move in the radial direction of the tank 11.

The anchor-type stirring paddle 122 is arranged coaxially with the first stirring shaft 121, and the anchor-type stirring paddle 122 is driven by the first stirring shaft 121 to rotate. When the anchor-type stirring paddle 122 rotates, it is capable of generating a propulsion force in the radial direction on the materials, so that the materials in the tank 11 move in the radial direction.

The anchor-type stirring paddle 122 has advantages of a wide viscosity range and low energy consumption. Therefore, it is capable of improving an application range of the stirring device and saving power consumption.

Optionally, the first stirring mechanism 12 further includes a first driving member 123 arranged outside the tank 11, and the first driving member 123 is connected to the other end of the first stirring shaft 121 to drive the first stirring shaft 121 to rotate, thereby driving the anchor-type stirring paddle 122 to rotate.

The first driving member 123 is capable of realizing automatic stirring of the first stirring mechanism 12.

Optionally, a blade of the anchor-type stirring paddle 122 in the present embodiment may be configured as a round anchor or a cone anchor.

In some embodiments, a radial-flow type such as a blade combination type, a straight paddle type, and a sawtooth disc type may also be used instead of the anchor-type stirring paddle. A ribbon type, a screw type, a fan type and the like may be utilized to replace the propeller.

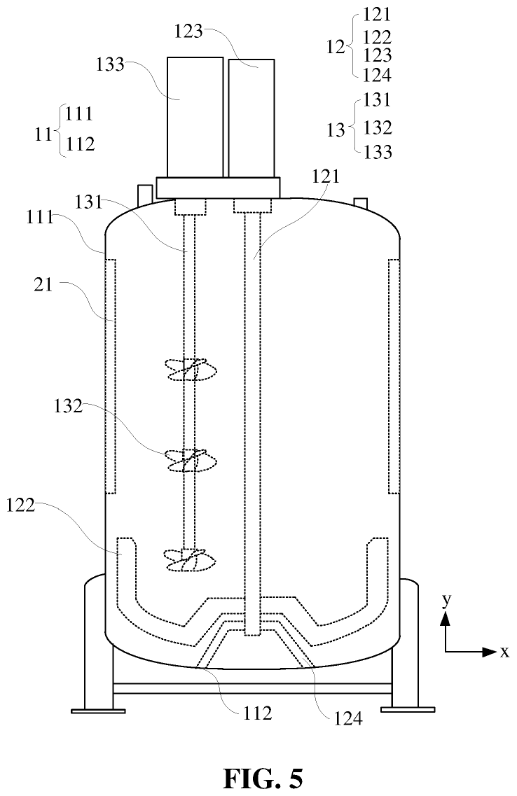

In some embodiments, as shown in FIG. 5, FIG. 5 is a schematic structural diagram of a fourth embodiment of a stirring device according to the present application, the first stirring mechanism 12 further includes: a supporting member 124 arranged on the bottom wall 112 of the tank 11, and configured to support one end of the first stirring shaft 121 connected to the anchor-type stirring paddle 122.

The bottom wall 112 of the tank 11 refers to the bottom wall of the accommodating chamber.

The supporting member 124 is fixedly arranged on the bottom wall of the tank 11, and the first stirring shaft 121 is connected to the anchor-type stirring paddle 122 and extends to the supporting member 124, and is rotatably connected to the supporting member 124, so that the supporting member 124 is capable of limiting the first stirring shaft 121 and is capable of causing the first stirring shaft 121 to rotate smoothly with respect to the tank 11.

Optionally, a position-limit hole is arranged on one side of the supporting member 124 away from the bottom wall of the tank 11, and the first stirring shaft 121 is connected to the anchor-type stirring paddle 122 and embedded in the position-limit hole. Alternatively, one end of the first stirring shaft 121 connected to the anchor-type stirring paddle 122 is rotatably connected to the supporting member 124 through an auxiliary member such as a bearing.

In some embodiments, as shown in FIG. 1, FIG. 2, FIG. 4, and FIG. 5, the anchor-type stirring paddle 122 is arranged close to the bottom wall 112 of the tank 11, and is located between the propeller 132 and the bottom wall 112 of the tank 11 in the axial direction of the tank 11.

When the propeller 132 rotates, it is capable of generating an upward propulsion force on the materials, so that the materials at the position of the tank 11 provided with the propeller 132 move upward.

The anchor-type stirring paddle 122 is arranged close to the bottom wall 112 of the tank 11, so that the anchor-type stirring paddle 122 is capable of driving the materials to move in the radial direction of the tank 11 to the side wall 111 of the tank 11 and then move upward along the side wall 111, so that the rising materials are driven by the propeller 132 to move upward continuously. The anchor-type stirring paddle 122 is arranged away from the top of the tank 11, and therefore, the centrifugal force of the materials on an upper part of the tank 11 is small, and the materials are capable of being pushed to the other side of the first stirring shaft 121, that is, the side where the propeller 132 is not arranged, and the materials are not affected by the propeller 132 on this side, or in other words, is hardly affected, and the materials will move downward on the other side, thereby forming a circulation that moves vertically and horizontally.

Of course, in other embodiments, if the driving power of the above driving member is relatively large, the anchor-type stirring paddle may also be arranged close to the top wall of the tank. In the axial direction of the tank, the anchor-type stirring paddle is located between the propeller and the top wall of the tank.

Optionally, the propeller 132 includes: a hub and a blade, the hub is connected to the other end of the second stirring shaft 131, and the blade is connected to the outer periphery of the hub.

The propulsion direction of the propeller 132 may be set by setting a rotation direction thereof.

Optionally, the propeller 132 in the present embodiment may include a plurality of independent blades arranged at intervals in the circumferential direction of the second stirring shaft 131, or include continuous annular blades.

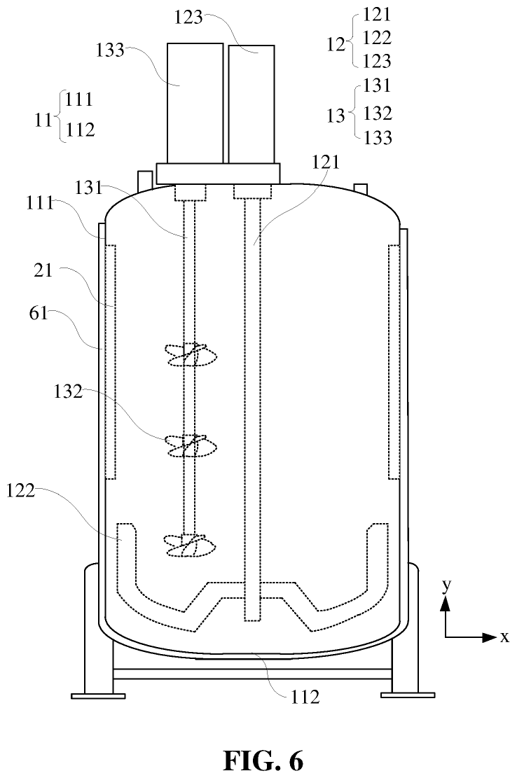

In some embodiments, as shown in FIG. 6, FIG. 6 is a schematic structural diagram of a fifth embodiment of a stirring device according to the present application. The stirring device of the present embodiment further includes a jacket 61 arranged outside the tank 11 and configured to accommodate a temperature regulator.

The jacket 61 outside the tank 11 is capable of adjusting the temperature of the materials in the tank 11 through the injected temperature regulator such as a cooling liquid or a heating liquid, so that the materials may always maintain a suitable temperature, thereby improving the material mixing effect.

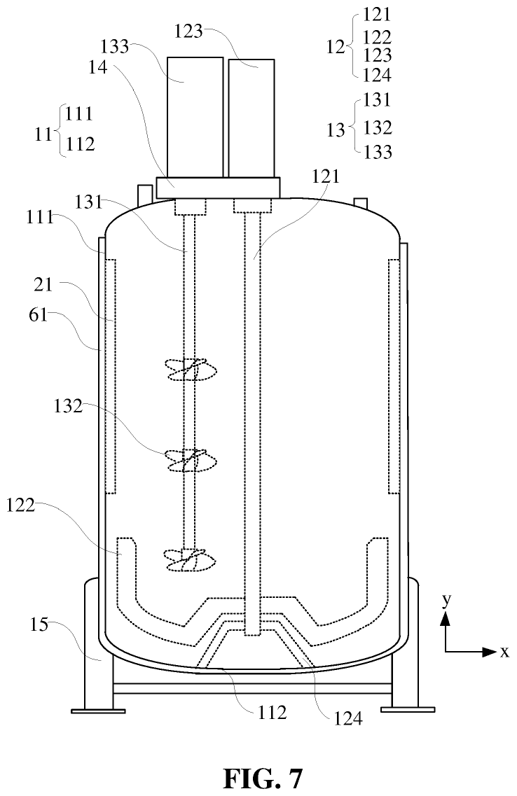

In some embodiments, as shown in FIG. 7, the stirring device includes a tank 11, a first stirring mechanism 12, a second stirring mechanism 13, a flow blocking plate 21, and a jacket 61. A first stirring shaft 121 of the first stirring mechanism 12 is located at the middle part of the tank 11, and one end of the first stirring shaft 121 is provided with a radial-flow stirring paddle located in the tank 11. A second stirring shaft 131 of the second stirring mechanism 13 is arranged in the tank 11, and is located on one side of the first stirring shaft 121 of the first stirring mechanism 12, one end of the second stirring shaft 131 is provided with an axial-flow stirring paddle located in the tank 11. The flow blocking plate 21 is arranged on a side wall 111 of the tank 11 in an axial direction of the tank 11. The jacket 61 is arranged outside the tank 11 and is configured to accommodate a temperature regulator.

The first stirring mechanism 12 is configured to drive the materials in the tank 11 to move in the radial direction x of the tank 11. The second stirring shaft 131 of the second stirring mechanism 13 is arranged in the tank 11 and located on the side of the first stirring shaft 121 of the first stirring mechanism 12, and is configured to drive the materials to move in an axial direction y of the tank 11.

The present embodiment may utilize the radial-flow stirring paddle on the first stirring shaft 121 in the middle part of the tank 11 to drive the materials in the tank 11 to move in the radial direction of the tank 11, and may use the axial-flow stirring paddle on the second stirring shaft 131 located on the side of the first stirring shaft 121 to drive the materials in the tank 11 to move in the axial direction of the tank 11, so that the materials in the tank move horizontally and vertically. Because the second stirring shaft 131 of the second stirring mechanism 13 is located on one side of the first stirring shaft 121 of the first stirring mechanism 12, the materials moving vertically by the second stirring mechanism 13 are capable of being squeezed to the other side of the first stirring shaft 121, so as to form a circulation that flows horizontally and vertically, so that the materials in the tank may be evenly dispersed, thereby alleviating the problem of radial stratification of the materials, and then improving the material dispersion and stirring effects.

Moreover, the present embodiment further arranges the flow blocking plate 21 in the tank 11, so that the circulation that flows horizontally and vertically in the tank 11 hits the flow blocking plate 21, and the materials after hitting the flow blocking plate 21 are scattered irregularly, which increases the hedging movement between the materials, and then makes the materials in various positions in the tank 11 get uniform dispersion; therefore, it is capable of further alleviating the problem of radial stratification of the materials, and further improving the material dispersion and stirring effects.

Moreover, the jacket 61 outside the tank 11 is capable of adjusting the temperature of the materials in the tank 11 through the injected temperature regulator such as a cooling liquid or a heating liquid, so that the materials may always maintain a suitable temperature, thereby improving the material mixing effect.

Further, the flow blocking plate 21 is arranged to be perpendicular to the side wall 111 of the tank 11. After the materials in the tank 11 move to the side wall 111 of the tank 11, they will flow in a circumferential direction of the side wall 111 of the tank 11 to form a horizontal circulation. Therefore, arranging the flow blocking plate 21 to be perpendicular to the side wall 111 of the tank 11 is capable of increasing a blocking area of the flow blocking plate 21 on the materials, thereby being capable of improving the material dispersion effect.

Further, the flow blocking plate 21 is fixedly connected to the side wall 111 of the tank 11, which is capable of improving the stability between the flow blocking plate 21 and the tank 11, thereby improving the quality of the stirring device, and is also capable of simplifying a mounting structure of the flow blocking plate 21, thereby simplifying the structure of the stirring device.

Further, the stirring device of the present embodiment includes a plurality of flow blocking plates 21, and the plurality of flow blocking plates 21 are arranged symmetrically with respect to the first stirring shaft 121. The first stirring shaft 121, serving as a central stirring shaft of the stirring device, drives the materials in the tank 11 to move in the radial direction of the tank 11 and forms the horizontal circulation, and therefore, arranging the plurality of flow blocking plates 21 on the side wall 111 of the tank 11 in the axial direction of the tank 11 and symmetrical with respect to the first stirring shaft 121 is capable of improving the dispersion and stirring effects of the materials at various positions in the tank 11.

Further, the flow blocking plate 21 may further be provided with a through hole, which is capable of preventing the materials from being accumulated between the flow blocking plate 21 and the tank 11, and the blocked materials are capable of flowing out from the through hole.

Further, the axial-flow stirring paddle includes: a propeller 132 connected to one end of the second stirring shaft 131 located in the tank 11, wherein an axial direction of the propeller 132 is arranged parallel to the axial direction of the second stirring shaft 131, and the propeller 132 is configured to drive the materials in the tank 11 to move in the axial direction of the tank 11.

The propeller 132 is arranged coaxially with the second stirring shaft 131, and the propeller 132 is driven by the second stirring shaft 131 to rotate. When the propeller 132 rotates, it is capable of generating an upward or downward propulsion force on the materials, so that the materials in the tank 11 move vertically.

Further, the second stirring mechanism 13 further includes the second driving member 133 arranged outside the tank 11, and the second driving member 133 is connected to the other end of the second stirring shaft 131 to drive the second stirring shaft 131 to rotate, thereby driving the propeller 132 to rotate. The second driving member 133 is capable of realizing automatic stirring of the second stirring mechanism 13.

Further, the second stirring mechanism 13 of the present embodiment includes a plurality of propellers 132, and the plurality of propellers 132 are arranged on the second stirring shaft 131 at intervals in the axial direction of the second stirring shaft 131.

The plurality of propellers 132 in the present embodiment are all arranged coaxially with the second stirring shaft 131, which is capable of improving the propulsion force of the second stirring mechanism 13 on the materials in the axial direction; and the plurality of propellers 132 are arranged at intervals, which is capable of reducing resistances of the propellers 132 to the materials.

Further, the radial-flow stirring paddle includes: an anchor-type stirring paddle 122, which is connected to one end of the first stirring shaft 121 located in the tank 11, and the axial direction of the anchor-type stirring paddle 122 is arranged parallel to the axial direction of the first stirring shaft 121. The anchor-type stirring paddle 122 is configured to drive the materials in the tank 11 to move in the radial direction of the tank 11.

The anchor-type stirring paddle 122 is arranged coaxially with the first stirring shaft 121, and the anchor-type stirring paddle 122 is driven by the first stirring shaft 121 to rotate. When the anchor-type stirring paddle 122 rotates, it is capable of generating a propulsion force in the radial direction on the materials, so that the materials in the tank 11 move in the radial direction.

The anchor-type stirring paddle 122 has advantages of a wide viscosity range and low energy consumption. Therefore, it is capable of improving an application range of the stirring device and saving power consumption.

Further, the first stirring mechanism 12 further includes a first driving member 123 arranged outside the tank 11, and the first driving member 123 is connected to the other end of the first stirring shaft 121 to drive the first stirring shaft 121 to rotate, thereby driving the anchor-type stirring paddle 122 to rotate. The first driving member 123 is capable of realizing automatic stirring of the first stirring mechanism 12.

Further, the first stirring mechanism 12 further includes: a supporting member 124 arranged on the bottom wall 112 of the tank 11, and configured to support one end of the first stirring shaft 121 connected to the anchor-type stirring paddle 122, so that the supporting member 124 is capable of limiting the first stirring shaft 121 and is capable of causing the first stirring shaft 121 to rotate smoothly with respect to the tank 11.

Further, the anchor-type stirring paddle 122 is arranged close to the bottom wall 112 of the tank 11, and is located between the propeller 132 and the bottom wall 112 of the tank 11 in the axial direction of the tank 11.

The anchor-type stirring paddle 122 is arranged close to the bottom wall 112 of the tank 11, so that the anchor-type stirring paddle 122 is capable of driving the materials to move in the radial direction of the tank 11 to the side wall 111 of the tank 11 and then move upward along the side wall 111, so that the rising materials are driven by the propeller 132 to move upward continuously. The anchor-type stirring paddle 122 is arranged away from the top of the tank 11, and therefore, the centrifugal force of the materials on an upper part of the tank 11 is small, and the materials are capable of being pushed to the other side of the first stirring shaft 121, that is, the side where the propeller 132 is not arranged, and the materials are not affected by the propeller 132 on this side, or in other words, is hardly affected, and the materials will move downward on the other side, thereby forming a circulation that moves vertically and horizontally.

Further, the radius of the anchor-type stirring paddle 122 is close to the inner diameter of the tank 11, so that the end of the anchor-type stirring paddle 122 is close to the side wall 111 of the tank 11, which is capable of increasing the stirring area of the anchor-type stirring paddle 122, capable of alleviating the problem of material sticking to the side wall 111, and capable of improving the material stirring effect. A projection of the propeller 132 on the bottom wall 112 is located in a projection of the anchor-type stirring paddle 122 on the bottom wall 112. On the one hand, it is convenient to arrange the flow blocking plate 21 on the side wall 111; and on the other hand, it is capable of causing the materials to rise rapidly from the bottom wall 112.

Further, the stirring device further includes an upper head 14, which covers the top of the tank 11, and specifically, covers an opening of the accommodating chamber, for sealing the opening.

Optionally, the above driving member in the present embodiment may include a motor or the like. The motor is located outside the top of the tank 11, and specifically, it may be arranged on the side of the upper head 14 away from the tank 11, so as to facilitate connection with the above stirring shaft arranged in the axial direction, and be capable of improving the driving efficiency of the motor.

Optionally, the first driving member includes a first variable frequency motor, such as a variable frequency motor with a parameter of 0-60 RPM/MIN, and the second driving member includes a second variable frequency motor, such as a variable frequency motor with a parameter of 0-800 RPM/MIN. The rotational speed and the like of the variable frequency motor may be changed according to specific requirements of various stirring stages in the stirring process to improve the material stirring effect.

In some application scenarios, the rotational speed of the second variable frequency motor is controlled at 0-800 RPM/MIN, which is capable of preventing the materials from being cut and demulsified by the propeller 132.

Further, one end of the above stirring shaft connected to the motor extends from the opening to the outside of the tank 11, and a mechanical seal ring may also be arranged at the connection between the above stirring shaft and the upper head 14, which is capable of alleviating the problem of liquid leakage from the connection.

Further, the upper head 14 may also be connected to the tank 11 through a flange.

Further, the stirring device further includes supporting legs 15 arranged outside the bottom wall of the tank 11, and used for mounting the tank 11 on a square platform to improve its stability.

The embodiment of the present application adopts the central anchor-type stirring paddle to drive the materials to flow in the radial direction, and the side propeller disturbs the materials to move vertically. The moving materials continuously circulate vertically and horizontally, and hit the flow blocking plate in the tank, so that the slurries in various positions are evenly dispersed, which is capable of alleviating, through the joint action of the anchor-type stirring paddle, the propeller, and the flow blocking plate, the phenomenon of serious stratification of materials due to the centrifugal force.

The above descriptions are implementation manners of the present application, and are not intended to limit the scope of the present application. Any equivalent structure or equivalent flow variation made by using the description and accompanying drawings of the present application and applied directly or indirectly in other related technical fields shall all fall within the protection scope of the present application.

What is claimed is:

1. A stirring device, comprising:
a tank;
a first stirring mechanism, a first stirring shaft of the first stirring mechanism being located in a middle part of the tank, and one end of the first stirring shaft being provided with a radial-flow stirring paddle located in the tank;
a second stirring mechanism, a second stirring shaft of the second stirring mechanism being located on one side of the first stirring shaft, the second stirring shaft and the first stirring shaft being arranged in a radial direction of the tank, and one end of the second stirring shaft being provided with an axial-flow stirring paddle located in the tank; and
a flow blocking mechanism, located in the tank and arranged on a side wall of the tank, and configured to block movement of materials in the tank.

2. The stirring device according to claim 1, wherein the flow blocking mechanism comprises:
a flow blocking plate arranged on the side wall in an axial direction of the tank.

3. The stirring device according to claim 2, wherein the flow blocking plate is arranged to be perpendicular to the side wall.

4. The stirring device according to claim 2, wherein the flow blocking plate is fixedly connected to the side wall.

5. The stirring device according to claim 2, wherein the flow blocking plate is one of a plurality of flow blocking plates of the flow blocking mechanism, and the plurality of flow blocking plates are arranged symmetrically with respect to the first stirring shaft.

6. The stirring device according to claim 1, wherein the axial-flow stirring paddle comprises:
a propeller connected to one end of the second stirring shaft located in the tank, wherein an axial direction of the propeller is arranged parallel to an axial direction of the second stirring shaft, and the propeller is configured to drive the materials in the tank to move in the axial direction.

7. The stirring device according to claim 6, wherein the propeller is one of a plurality of propellers of the second stirring mechanism, and the plurality of propellers are arranged on the second stirring shaft at intervals in the axial direction of the second stirring shaft.

8. The stirring device according to claim 6, wherein the radial-flow stirring paddle comprises:
an anchor-type stirring paddle, connected to one end of the first stirring shaft located in the tank, and an axial direction of the anchor-type stirring paddle being arranged parallel to an axial direction of the first stirring shaft, wherein the anchor-type stirring paddle is configured to drive the materials in the tank to move in the radial direction of the tank.

9. The stirring device according to claim 8, wherein the first stirring mechanism further comprises:
a supporting member arranged on a bottom wall of the tank and configured to support one end of the first stirring shaft connected to the anchor-type stirring paddle.

10. The stirring device according to claim 8, wherein the anchor-type stirring paddle is arranged close to a bottom wall of the tank, and is located between the propeller and the bottom wall in the axial direction of the tank.

11. The stirring device according to claim 1, further comprising:
a jacket arranged outside the tank and configured to accommodate a temperature regulator.
